(19) United States
(12) Patent Application Publication
(10) Pub. No.: US 2016/0307206 A1
(43) Pub. Date: Oct. 20, 2016

(54) ARRANGEMENT FOR DETECTING COUNTERFEIT PRODUCTS

(71) Applicant: CARL FREUDENBERG KG, Weinheim (DE)

(72) Inventors: Knuth Fickartz, Schoenau (DE); Uwe Haefner, Kehl (DE)

(21) Appl. No.: 15/100,320

(22) PCT Filed: Oct. 20, 2014
(86) PCT No.: PCT/EP2014/002823

§ 371 Date: May 30, 2016

(30) Foreign Application Priority Data
Dec. 2, 2013 (DE) 10 2013 018 036.8

(51) Int. Cl. G06Q 30/00; G06K 9/68

(52) U.S. Cl. CPC G06Q 30/0185; G06K 9/68

(57) ABSTRACT

An arrangement has a device which has at least one individualizing feature, detecting unit for detecting the individualizing feature, and a data storage unit in which the individualizing feature is stored and uniquely assigned to the device. The arrangement can reliably ascertain the authenticity of a product. The individualizing feature can be detected by the detecting unit and compared to the stored individualizing feature, which has already been stored in the data storage unit.

### CROSS-REFERENCE TO RELATED APPLICATIONS

This application is a U.S. national stage application under 35 U.S.C. §371 of International Application No. PCT/EP2014/002823, filed on Oct. 20, 2014, and claims benefit to German Patent Application No. DE 10 2013 018 036.8, filed on Dec. 2, 2013. The International Application was published in German on Jun. 11, 2015, as WO 2015/082024 A1 under PCT Article 21(2).

### FIELD

The invention relates to a sensing arrangement.

### BACKGROUND

The prior art has already disclosed the practice of identifying products by means of electronic chips, codes or other means in order to ensure their authenticity. The previously mentioned codes are often based on an algorithm.

As soon as a potential product counterfeiter has captured and understood the algorithm using some original products, the counterfeiter can imitate further products and provide them with the code. It is then possible only with great difficulty to distinguish these counterfeit further products from original products which continue to be delivered.

This results in a multiplicity of disadvantages for companies, namely, on the one hand, exploitation of reputation and, on the other hand, a liability risk, namely if the company must prove that defective products do not come from its production.

### SUMMARY

An aspect of the invention provides an arrangement, comprising: an apparatus including an individualizing feature; a capture unit configured to sense the individualizing feature; and a data memory in which the individualizing feature is stored and explicitly associated with the apparatus, wherein the individualizing feature can be sensed by the capture unit and can be compared with a deposited instance of the individualizing feature that is already stored in the data memory.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a filter element having bellows accommodated by a frame;

FIG. 2 shows a perspective view of the filter element according to FIG. 1, in which case individualizing features, namely a drip nose and a positive mark and a negative mark, are provided and have a particular relative orientation with respect to one another;

FIG. 3 shows a schematic view of an arrangement comprising a data memory, a capture means and a filter element; and

FIG. 4 shows a schematic view of the data memory, in which case the deposited instances stored in it are schematically illustrated.

### DETAILED DESCRIPTION

Therefore, an aspect of the invention is based on configuring and developing an arrangement of the type mentioned at the outset such that the authenticity of a product can be determined as reliably as possible.

According to an aspect of the invention, it has been recognized that the authenticity of a product can be determined by sensing an individualizing feature and comparing it with a deposited instance of this individualizing feature that was already stored at an earlier time. The invention uses the fact that each product is a unique item and is uniquely identified by one or more individualizing features characteristic of it. Specifically, use is made of the fact that the product counterfeiter cannot know at all which physical feature is used as the individualizing feature and was stored in the data memory at the factory.

Against this background, the individualizing feature could be optically sensed by the capture means and the deposited instance could be embodied as an optical representation of the individualizing feature that is already stored in the data memory. In this case, it is advantageous that images of individualizing features can be very easily generated in situ and can also be stored as files.

The apparatus could bear a serial mark that is likewise stored in the data memory and explicitly associated with the individualizing feature. As a result, the authenticity of each product bearing a serial mark of a particular company can be checked. This is because only the company has a database in which a particular serial mark is associated with a particular individualizing feature. Moreover, a product counterfeiter would not know at all which physical feature was selected by the company as the individualizing feature.

Each individualizing feature could differ from other individualizing features from other apparatuses and/or could be stored in the data memory only once. As a result, each product can be identified as a unique item.

The capture means could be embodied as a camera. A camera or a mobile telephone with a photo function can be easily carried by market researchers and can be networked to a database of a data memory via the Internet.

The apparatus could be embodied as a filter element. Filter elements are used in highly sensitive technical areas in which damage to people's health cannot be excluded if unsuitable filter elements are used. Therefore, there is a need for product counterfeiting protection here.

The individualizing feature could be conditional upon production. As a result, an individualizing feature which characterizes the product uniquely, arbitrarily and in a non-reproducible manner can be produced during or after production.

Conditional upon production may be additional printing of individualizing features. However, the intention is also to include individualizing features which are usually introduced into the product anyway during the process of producing the product. These individualizing features are used for individualization without carrying out a particular production step. For example, an individualizing feature could be produced during injection molding without carrying out a particular production step for this purpose.

Against this background, the individualizing feature could be embodied as a drip nose for a frame. Filter elements often have plastic frames which are injection-molded. Harmless plastic drip noses may be produced during this production process and can be used to uniquely identify a filter element. Every drip nose differs from another on account of the arbitrary manner in which they are produced.

The individualizing feature could be embodied as a relative orientation for two marks. The relative positioning of the marks with respect to one another is difficult to reproduce if it is different for each product.

The arrangement described here is preferably used to carry out a method for detecting the authenticity of a product. The method can be carried out in the field after data which identify the product or the apparatus have been acquired during or after production at the factory.

It is also conceivable to apply an individualizing feature to the apparatus by means of a sticker.

An individualizing feature may be embodied as a hole, an electrical resistance, a particular Rockwell hardness or a degree of crystallization.

The individualizing feature can be arbitrarily selected and cannot be reproduced. Arbitrary individualizing features are produced during the production of an apparatus, for example.

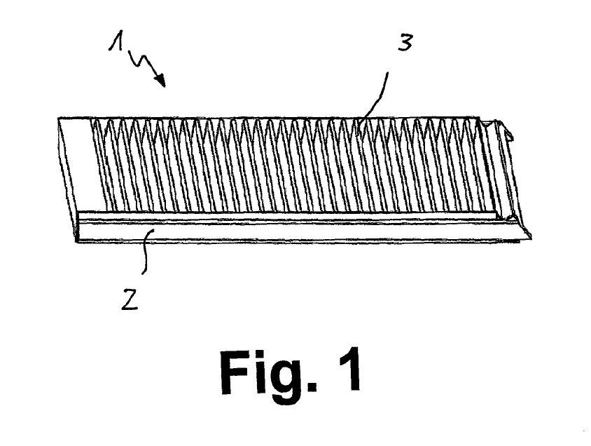

FIG. 1 shows an apparatus 1, namely a product which is embodied as a filter element. The filter element has a frame 2 which accommodates bellows 3. The frame 2 is produced from plastic and is molded onto the bellows 3 using injection molding.

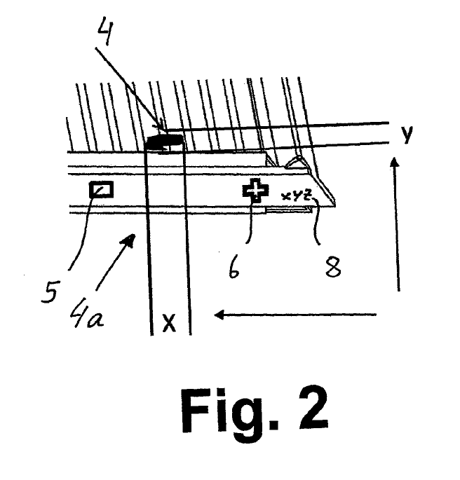

FIG. 2 shows an area of the apparatus 1, namely of the filter element, which has individualizing features 4, 4a.

An individualizing feature 4 is embodied as a drip nose for the frame 2. This individualizing feature 4 is conditional upon production. It occurs during the injection-molding process.

A further individualizing feature 4a is embodied as a relative orientation for two marks 5, 6. The positive mark 6 and the negative mark 5 are arranged at particular locations of the frame 2 and have a particular relative orientation with respect to one another. This is different in every other apparatus.

A serial mark 8 is also arranged on the frame 2. This serial mark 8 is embodied as a part number of the filter element.

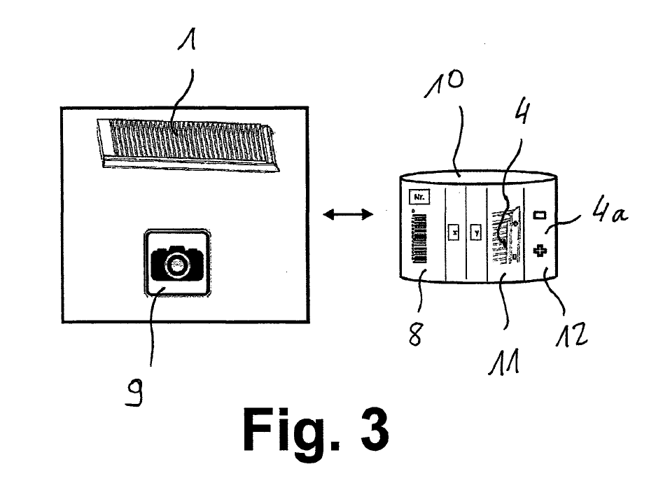

FIG. 3 schematically shows an arrangement comprising an apparatus 1 that has at least one individualizing feature 4, 4a, a capture means 9 for sensing the individualizing feature 4, 4a, and a data memory 10 in which the individualizing feature 4, 4a is stored and explicitly associated with the apparatus 1.

The individualizing feature 4, 4a can be sensed by the capture means 9 and can be compared with a deposited instance of the individualizing feature 4, 4a that is already stored in the data memory 10.

Specifically, the individualizing feature 4, 4a can be optically sensed by the capture means 9 and the deposited instance is specifically embodied as an optical representation 11, 12 of the individualizing feature 4, 4a that is already stored in the data memory 10. The representation 11, 12 is preferably stored as a file or an image file in the data memory 10.

The individualizing feature 4, 4a can be optically sensed by the capture means 9 and can be compared with an optical representation 11, 12 of the individualizing feature 4, 4a that is already stored in the data memory 10 at the factory.

The apparatus 1 bears a serial mark 8 that is likewise stored in the data memory 10 and is explicitly associated with the individualizing feature 4, 4a.

Each individualizing feature 4, 4a differs from other individualizing features from other apparatuses.

Each individualizing feature 4, 4a is stored in the data memory only once.

The capture means 9 is embodied as a camera.

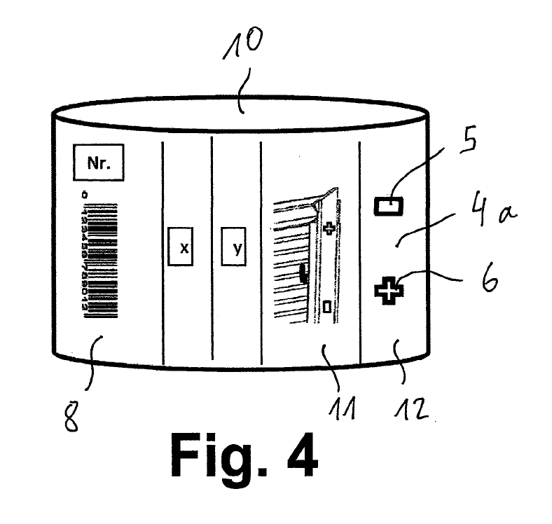

FIG. 4 shows a further illustration of the data memory 10.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

1. An arrangement, comprising:
an apparatus including an individualizing feature;
a capture unit configured to sense the individualizing feature; and
a data memory in which the individualizing feature is stored and explicitly associated with the apparatus,
wherein the individualizing feature can be sensed by the capture unit and can be compared with a deposited instance of the individualizing feature that is already stored in the data memory.

2. The arrangement of claim 1, wherein the individualizing feature can be optically sensed by the capture unit, and
wherein the deposited instance is embodied as an optical representation of the individualizing feature that is already stored in the data memory.

3. The arrangement of claim 1, wherein the apparatus bears a serial mark that is likewise stored in the data memory and explicitly associated with the individualizing feature.

4. The arrangement of claim 1, wherein each individualizing feature differs from other individualizing features from other apparatuses and/or is stored in the data memory only once.

5. The arrangement of claim 1, wherein the capture unit includes a camera.

6. The arrangement of claim 1, wherein the apparatus includes a filter element.

7. The arrangement of claim 1, wherein the individualizing feature is conditional upon production.

8. The arrangement of claim 1, wherein the individualizing feature includes a drip nose for a frame.

9. The arrangement of claim 1, wherein the individualizing feature includes a relative orientation for two marks.

10. A method for identifying the authenticity of an apparatus, the method comprising:
sensing the apparatus in the arrangement of claim 1.

11. The arrangement of claim 1, wherein each individualizing feature differs from other individualizing features from other apparatuses. and/or is stored in the data memory only once.

12. The arrangement of claim 1, wherein each individualizing feature is stored in the data memory only once.

13. The arrangement of claim 11, wherein each individualizing feature is stored in the data memory only once.

14. The arrangement of claim 1, wherein the capture unit is a camera.

15. The arrangement of claim 1, wherein the apparatus is a filter element.

16. The arrangement of claim 1, wherein the individualizing feature is a drip nose for a frame.

17. The arrangement of claim 1, wherein the individualizing feature is a relative orientation for two marks.

18. The arrangement of claim 1, wherein the apparatus includes a serial mark, and
wherein the serial mark is stored in the data memory and explicitly associated with the individualizing feature.
